(19) United States
(12) Patent Application Publication
(10) Pub. No.: US 2010/0101231 A1
(43) Pub. Date: Apr. 29, 2010

(54) PROCESS FOR A HIGH EFFICIENCY AND LOW EMISSION OPERATION OF POWER STATIONS AS WELL AS FOR STORAGE AND CONVERSION OF ENERGY

(76) Inventor: Siegfried Westmeier, Halle (DE)

Correspondence Address: MCGLEW & TUTTLE, PC, P.O. BOX 9227, SCARBOROUGH STATION, SCARBOROUGH, NY, 10510-9227, US

(21) Appl. No.: 12/376,003

(22) PCT Filed: Jul. 28, 2007
(86) PCT No.: PCT/DE07/01346

§ 371 Date: Oct. 21, 2009

(30) Foreign Application Priority Data
Jul. 31, 2006 (DE) 10 2006 035 273.4

(51) Int. Cl. F02C 6/00

(52) U.S. Cl. 60/783; 290/52

(57) ABSTRACT

The invention relates to a process and a device for process realizing to increase the efficiency of power stations by improvement of the efficiency of using the heat potentials for an electric power production by using of supercritical carbon dioxide as a working fluid and heat transfer medium as well as for the improvement of the ecological balance of power stations by minimization of the carbon dioxide emission and the total avoidance of NOₓ-emissions by using of pure oxygen for the burning process. Additionally the process allows the buffering of electric overcapacity energy producing mass storages for natural gas, pressed air and carbon dioxide and their effective using as well as in the continuous operation and for peak load supply of power stations.

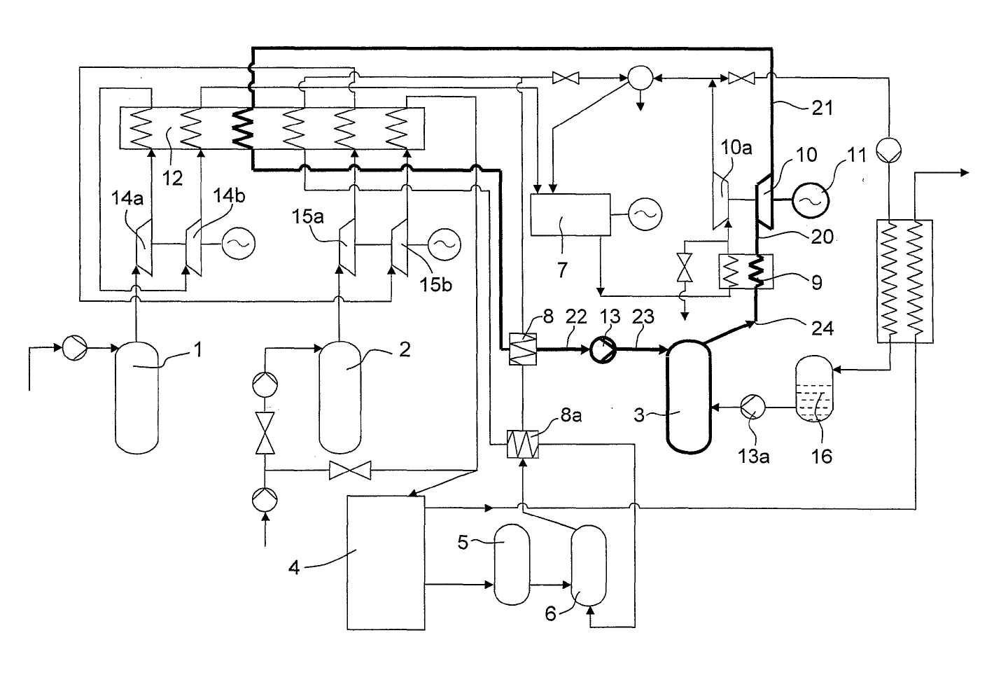

The invention relates to a process and a technical device for a better using of heat potentials of a power station and its surrounding as well as connected plants with it for the reduction of carbon dioxide and NOₓ emissions in the environment as well as buffering and reusing of electric energy.

### FIELD AND BACKGROUND OF THE INVENTION

The invention is characterized by a complex system of components to find a solution on the given requests in the energy sector. The plant concept has to fulfill the following aims in detail:
Using of electrical overcapacities for foundation of mass storages and its using for reusing of electrical energy with a high efficiency.
Creating a power station without emissions,
Using the expansion energy and the connected different heat potentials with it for the production of electricity,
Optimal using low temperature heat capacities for electric power generation,
Using thermal energy potentials of connected plants for the increasing of the electrical efficiency of the whole plant and
Using thermal energy potentials of surrounding of the plant.

There was not found references in the literature to a similar compact and cross-linked plant as invited in spite of an intensive investigation. For this reason the following patent and literature investigations are made separately in the different fields of the invention.

For the buffering of electrical energy are proved to be pump-fed power stations as the most effective methods. Advantageously at this plant technology is the high efficiency as well as the relatively simple technology. Disadvantageously at this technology is the high landscape consumption, the limitation to relatively few suitable locations and the high water losses by evaporation. For the storage of electricity of wind energy the suitable locations are rarely, because the most wind power plants are situated in the plain country or offshore and the pump-fed power stations needs a mountainous area. In this situation the advantage of the storage will be low, because the long electric conductors and the unloading of the networks are not given.

A second possibility is given by development of buffer storages for compressed air in the underground, which are filled in the USA with overcapacity electrical energy and used as a power plant due expansion of the pressured air through a turbine connected with a generator. Advantageously in this process is the relatively simple technology and the using the air as working fluid.

Disadvantageously are the high energy losses at the compression, the heavy heat emission and the low efficiency of the process.

Another possibility of the compressed air storage is discussed by using the compressed air at high pressure as input stream in a burner supported turbo machine (CAES-concept). In such way the compression of the burning air is not applicable and the total efficiency is increased.

Further is known and published in the patent specification sheet WO 01/33150 A1 that for lowering the production costs of technical gases an continuously working air separation plant is feed from a storage for compressed air which is filled discontinuously with pressured air in relation to a partial aspect of this invention. Because in this case the costs of production of technical gases are in the focus of the interest, the loss of the compression heat is a usual and planned energy loss. The energetic use of this heat was outside of discussion. Other experiments for the using of buffer storages for electrical energy, e.g. in batteries, are in development but can not to be used in the process.

The present discussion about the greenhouse effect and climate changes overcharges from the operators of the power plants an operation without emissions. Because the energy supplying concept is not to handle without fossil fuels, there are many projects, which are dealing with the separation of carbon dioxide from the exhaust air and their storage. The separation of carbon dioxide from exhaust air can be made with the known procedures condensation, absorption and adsorption. Different scenario will be tested for the longtime storage in relation to its effects to the environment as well as of its possible danger potentials for the future. On such way possibilities are considered for the storage of carbon dioxide in the deep sea, in underground rock formations and in horizons of former natural gas and oil fields.

There are very different points of views of such methods and the realization of one of these technologies is not clear. The economy of such procedures is not given because the locations of the power plants and the proper locations for storage of carbon dioxide are distant thousands of kilometers and the carbon dioxide has to be liquefied or solidified for the transport.

For the lowering of the NOₓ-emissions are known a set of procedures and state of the art. A NOₓ-free operation is possible in a burning process with pure oxygen and nitrogen-free accessory gases.

At this time is going a project for burning without nitrogen under the responsibility of Vattenfall in Schwarze Pumpe in Germany. In this case the separation of the carbon dioxide is taking place by the Oxyfuel-technology. From the initiators of the project is judged, that the process is very energy intensive and had a low efficiency. Besides the it is not easy to find usual locations for the storage.

Using of expansion energy for the production of energy is known and is putting into action e.g. at the air separation, the expansion of natural gas, and by using of compressed air storages for producing of energy. In the expansion of natural gas and compressed air the accompanied high cooling effect is not wanted and will be prevented, as possible, by preheating of the pressured medium. In air separation plants the cooling effect is used for liquefaction and separation of air into it components.

Low temperature heat from burning processes is used by two procedures essentially:

In the ORC (Organic-Rankine-Cycle)—process the heat is took off from a medium in a heat exchange process and used for the production of vapor, the vapor is labor-working expanded and driven a generator connected turbine, therein the expanded vapor is used for preheating of the pressured vapor and condensed. The heat of condensation is given up to the surrounding. The efficiency is depending on the temperature of condensation (temperature of the surrounding) of the used working fluids and the boiling temperature of nearly 300 K to 625 K. The reachable efficiency of an ORC-plant is given at the temperature level of 373 K nearly 6.5% and the temperature level of 473 K nearly 13-14%.

In the Kalina-process heat is took away from the process medium by a heat exchanger due an ammonia-water-mixture by driving off ammonia. The ammonia vapor is expanded through a turbine and is driving a connected generator. After them the ammonia is adsorbed in the cooled state in the ammonia-water-mixture. In this process is reachable the higher efficiency of nearly 18%. Advantageously in this process is the simpler construction of the plant too and a significant broader range of temperature of the working fluid. Disadvantageously are the material technical problems caused by the aggressiveness of the ammonia-water-mixture which will be caused a lower life time of this few experienced process. A second disadvantage is the possibility of the emission of the high toxic and environmental endangering ammonia by legs. Both processes are suiting for using low temperature heat potentials of the surrounding too. However the integration of this process is difficult and in such way there is not known practical examples therefore.

Other processes written in patents, are not technically realized at now. It is used CO₂ as working fluid in all three cases. The inventions writing in the patent bulletins DE 196 32 019 01 and EP 0 277 777 B1 are coming closest to the present invention. Supercritical carbon dioxide is used as working fluid in the patent bulletin DE 19632019 C1 for using of low temperature heat in the temperature range of 40 to 65° C. Into the bargain the pressure is chose in such way that the critical pressure is not falling short off. Compressing is taking place in the supercritical fluid range. The costs of compression for production of the higher working pressure are relatively high for this reason. Disadvantageously is the separation into a working and a heat streaming circuit which are coupled by a heat exchanger too. Subsequently are higher heat losses.

The using a storage of carbon dioxide at the triple point, describing in EP 0 277 777 B1, is a very interest way. The solid liquid carbon dioxide mixture is produced due a refrigerator by using overcapacities of electrical power. In times of energy requirements carbon dioxide is vaporized and used as a carbon dioxide vapor circuit. On this way a peak shaving of the energy e.g. in the day night cycle is possible.

Advantageously at this process is the using of overcapacity energy producing accumulator of cold, disadvantageously is the use of a relatively high minimum temperature of more than 200° C. in the case of low temperature heat using as well as the relatively low used working pressure, seen energetically. Further disadvantageously is the needed gas compression producing the working pressures. The efficiency of the plant producing electrical energy is influenced due both factors too. Calculations show that the efficiency of the plant is lower as the present invention.

In U.S. Pat. No. 4,995,234 and EP 0 277 777 B1 is used a similar basis principle for the using of the cold potential of LNG. The liquefaction of carbon dioxide is made by vaporizing of LNG. The heat is produced by sea water and a gas turbine. At this process is the using of seawater disadvantageously, advantageously is the using of LNG, but it limits the operating conditions. These processes are designing for using the cold potential of LNG for the vaporization and are not optimal to the power station process.

Likewise a process for using of geothermic heat is working with carbon dioxide as working fluid, specified in the patent bulletin U.S. Pat. No. 3,875,749. This process is working only in the fluid and gas region in such way that the carbon dioxide as working fluid takes off in compressed state geothermal heat from an underground storage and is expanded labor-working in a turbine. After then the carbon dioxide is compressed new into the fluid range. The complicated structure of the underground heat exchanger is disadvantageously in this process and the danger of a geothermal cool down of the surrounding of the storage is given. Because no parameters in relation to temperature and pressure are given an exact assessment of the process is not possible.

### Task Invention

Task invention is developing a process for the production of electric energy in a with a mixture oxygen and natural gas driven low emission gas turbine and fluid turbine power station (GuF-power station) by using of overcapacity electric energy of the network and using of carbon dioxide as working fluid with additional using of geothermal potential, with a higher energy efficiency as before and avoiding known and described previous as well as other defects, connected with a simple construction based on low material technical effort. The task is solved by a process and a technical device to realize this process with a better utilization rate of the heat potentials in operating the power plant, the total avoidance of NOₓ-emission, a significant lower emission of carbon dioxide in the environment, a good control by the optimal using of given and changeable ambient temperatures, minimization of the exhaust heat and an optimal operation in connection with a significant improvement of the electrical efficiency as well as the possibility to store the electrical power from temporary overcapacities and, after change, to use effective for increasing the efficiency of the power plant in the normal operation and preferably for peak load supply.

Different advantageous aspects of other solutions are integrated into the total concept in the development of the process, which is leaded to a clean power plant of a total new construction and operation by the combination of new technological components. It is used overcharged electrical energy, analogous to known processes but more effectively, charging high pressure storages of natural gas, pressed air, and carbon dioxide discontinuously in buffer storages in that way that the pressed air is used to produce liquid oxygen in a continuous working air separation plant, will be vaporized and used after then together with natural gas and carbon dioxide from the underground storage and partial from the exhaust gas as burning gas mixture at the input pressure of the gas turbine. The heat of vaporization of oxygen is used to liquefy the carbon dioxide which is used as heat carrier and working fluid. The storage of natural gas is serving as buffer and as cold source by the expansion of the storage pressure to the turbine input pressure and the carbon dioxide storage is the reservoir and buffer for carbon dioxide as heat transfer and working fluid for using the thermic potential of the plant and serving as heat sources too by using of the natural and stored geothermal potential. The carbon dioxide is filled with cold liquefied carbon dioxide and takes off from the surrounding heat, which is renewed by the compression heat of the other compressed gases as air and natural gas. Other than by other known solutions the carbon dioxide is used in a fluid form under high pressure and a normal temperature directly and can be used immediately for a quick start-up procedure of the gas turbine and the steam turbine, driven with carbon dioxide too as heat transfer and working fluid without a vaporization process and without other compression procedures. The input of pure oxygen and natural gas, as well as using of carbon dioxide as heat transfer and working fluid are allowing the thermodynamic and technologic effective joint of the unit components to a optimal power plant complex with a high electrical effectiveness, without NOₓ-emission as well as strong minimized emissions of carbon monoxide and carbon dioxide.

The thermal energy of the exhaust gas is taken off by supercritical carbon dioxide under high pressure as heat transfer fluid in the fluid power plant. After them the heated supercritical carbon dioxide fluid is labor-producing expanded due an expansion turbine connecting with a generator, cooling in this process and further cooling and liquefying by using a cold source and then compressing in liquid state to the working pressure and storing in the underground storage. As cold sources are used the cooling effects from the expansion of air, natural gas and carbon dioxide as well as the heat of vaporization of liquid oxygen and the cold potential of liquid and vaporized oxygen.

In the process the high effectiveness of the overall power plant is given by the chosen combination of the separate units of the plant and the combined using of the different thermodynamic potentials. All of the natural given and produced heat and pressure potentials are used producing electrical energy. The exhaust air stream, consisting at using clean natural gas from water and carbon dioxide only, cooled in the heat exchanger, is partially compressed to an optimal pressure for the gas turbine, mixed with pure oxygen or rather together with pure oxygen and natural gas injected into the combustion chamber of the gas turbine.

In start phase of filling the carbon dioxide storage the whole exhaust gas stream is compressed in different steps with intermediary drying and cooling and after them separated. The part of the dried exhaust air, which is not returned to the input of the gas turbine, is higher compressed, cooled with the exhaust air of the air separation plant and the containing carbon dioxide is liquefied and pumped by a liquid pump into the underground storage. In case of the filled underground carbon dioxide storage this process is used for replacement of losses or for winning of carbon dioxide as product in liquid or solid state.

### EXAMPLES OF APPLICATION

Further advantages are given by the description of an example of application of the invention by different temperatures of the using of heat with and without the using of a geothermic potential at 301 K as well as the connected figure and table with different modifications.

In the figure the principle of the construction of the device for the application of the process with using the geothermal potential is given schematically.

In the following example of the application the using of the decisive thermal potential is put into the centre of interest. The corresponding, with the numbers 20 to 24 characterized duct circuit is marked by increased lines. All of the other advantages are to understand by specialists direct and without other commentaries.

The most important parameters as transferred heats, temperatures and powers are given in the table in clearly visible form for the two temperatures 423 K and 473 K. The great advantage of the combination of different heat potentials is seen in a comparison of the variants A and B according to using the circuit with and without geothermal energy.

Temporary not usable electric energy is used for the compression and filling high pressure storages for natural gas 1, pressured air 2, and carbon dioxide discontinuously. The high pressure storage for air 2 is used as buffer for a continuous working air separation plant 4 for the production of liquid oxygen, which is stored in special cryogen containers 5 and, after its vaporization in an evaporation device 6, will be feed to the burning process in the gas turbine 7, in such way that the heat of vaporization of the liquid oxygen is contributed to liquefy the carbon dioxide which is used as heat transfer and working fluid in a first heat exchanger 8 at low temperatures. The high pressure storage for natural gas 1 is used for stocking and supplying the plant with fuel and the high pressure storage of carbon dioxide 3 is used on the one side as buffer for the supercritical carbon dioxide used as heat transfer and working fluid and has active tasks in the fluid circuit of the power station for increasing of the total efficiency by using the waste heat of the power station better for the production of electric energy under using of the geothermal energy potential.

Using of pure oxygen and natural gas as well as using of carbon dioxide as heat transfer fluid are permitting a thermodynamic and technical effective connection of the separate units of the plant in relation to the total efficiency, the NOₓ avoidance and the significant lowering of the carbon monoxide and carbon dioxide minimization.

In the vapor circuit unit of the power station consisting of a second heat exchanger 9, a expansion turbine 10 with partial recompressing of the cooled exhaust gas stream and a with the expansion turbine connected compressor 10a and generator 11 the thermic energy of the exhaust gas stream from the exit of the gas turbine 7 is taken off by the high pressure supercritical carbon dioxide as heat transfer fluid. After them the heated carbon dioxide stream is labor-producing expanded due a expansion turbine 10, which is connected with the generator 11, will be cooled in this process, liquefied by using of a cold source in a third heat exchangers 12 cooled, in the first heat exchanger 8 liquefied in such way that the temperatures in the first heat exchanger 8 by help of a separate oxygen circuit by using of a third heat exchanger 12 and a fifth heat exchanger 8a is controlled in such way that the carbon dioxide cannot be crystalline in the first heat exchanger 8, after them in the liquid state compressed to the working pressure due a first liquid pump 13, and again feed the carbon dioxide storage 3. As cold sources can be used, depending of the operation mode of the power plant, the expansion cold energies of the expansion units 14a and 14b of the reduction of natural gas, the expansion units of expansion 15a and 15b of pressured air, or the vaporization heat respectively the warming energy given cold sources and the waste cold of the air separation unit 4, as well as if required and possible the cold potentials of the surrounding. The exhaust gas stream, cooled in the second heat exchanger 9, partial compressed of an optimal pressure for the gas turbine 7 by the compressor 10a, which is connected with the expansion turbine 10 directly, or mixed with pure oxygen in a mixing chamber 25 respectively injected together with natural gas into the gas turbine 7 as cooling and working fluid. Charging the high pressure storage of carbon dioxide 3 in the commissioning of the power plant the whole exhaust gas stream is compressed, dried in such way that it is consisting as pure carbon dioxide nearly, further compressed, by the air of an air separation plant 4 in a forth heat exchanger 8b cooled, as a result liquefied, in the high pressure container collected and by a second liquid pump 13a in the high pressure storage for carbon dioxide 3 pumped. At filled underground storage this way is used too for refilling of losses or for the production of pure carbon dioxide in liquid or solid state.

Using of carbon dioxide as heat transfer and working fluid under pressure specially is advantageously for using of low temperature thermic energy for their conversation in electric energy. In this case carbon dioxide is liquefied at low temperatures, then compressed in the liquid state to supercritical pressures, taking off heat in this range, after them labor-working expanded due an expansion turbine connected with a generator in such way that the turbine is driving the generator, the carbon dioxide is cooled in this procedure and the final temperature of the carbon dioxide is set of the wanted pressure for the liquefaction. After them the carbon dioxide is liquefied at this pressure by a cold source, the heat of condensation is removed, and the following increasing of the pressure is made by a liquid pump to the wanted supercritical working pressure. The choice of the supercritical region is made for the heat absorption because the advantageous thermodynamic conditions for the heat exchange in this region at temperatures, which is of interest for using of low temperature heat for producing electrical energy. That is caused by high values of heat capacity, low values of viscosity, connected with values of thermal conductivity which are comparable with the values of steam. The thermodynamic useable range to low temperatures is limited by the triple point of carbon dioxide at nearly 217 K, corresponding with a pressure of nearly 0.55 MPa. To above there are no thermodynamic limits as well as in the temperature and pressure. Limitations of other sorts are given for practical and material reasons. Another advantage is given at the using of carbon dioxide in comparison to the ORC-process because no additional heat exchanger is necessary and the heat transfer medium and the working medium are identically in a closed circulatory control management. Advantageously is too, that carbon dioxide is using a low environmental dangerous potential and that the availability of carbon dioxide is relative high. In the used process the possibility is consisting too, using big amounts of carbon dioxide to use useful as working fluid connecting with using of geothermal or ambient heat for increasing of the efficiency of the whole process.

In such way significant advantages are given against the ORC-process and the Kalina-process.

Other advantages are given by higher efficiencies and the combination with heat and cold potentials, which are increasing further the effectiveness of the whole power station without additional input of fuels. This is being successful using the geothermal potential near the surface of the earth as well as using the cold sources which are given in expansion processes particularly to the expansion of natural gas and pressed air for the liquefaction of carbon dioxide The example of application is demonstrating this with a very high electrical effectiveness.

The process is used advantageously for removing and controlled storage of carbon dioxide because the big buffer as a contribution against the green house effect. The device to realize the process is permitting a discontinuous operation of the power plant with considerable changing conditions and operations modes without problems in the times of quick start-ups and adaptations.

An example for the using external heat potentials is given in the table. At a comparison between example 1a and 1b is to see that the using of a geothermal potential at the temperature of 301 K the effectiveness of the whole fluid is increased of nearly 7%.

TABLE

| | | | | Power | | | | | |
|---|---|---|---|---|---|---|---|---|---|
| Fluid | | | Pressure | kW | | Electr. | Electr. | Net | |
| flog | Unit | Temperature K | MPa | Therm. | Electr. | Gross | Net | Efficiency | Example |
| 20 | | 423 | 15 | | | | | | I a |
| | 10 + 11 | | | | 1015.5 | | | | |
| 21 | | 260 | 2.0 | | | | | | |
| | 8 + 12 | | | −289.5 | | | | | |
| 22 | | 253 | 2.0 | | | | | | |
| | 13 | | | | −124 | | | | |
| 23, 24 | | 260 | 15 | | | | | | |
| | 9 | | | 3788 | | | | | |
| | | | | | | 1015.5 | 890 | 23.5% | |
| 20 | | 423 | 15 | | | | | | I b |
| | 10 + 11 | | | | 1015.5 | | | | |
| 21 | | 260 | 2 | | | | | | |
| | 8 + 12 | | | −289.5 | | | | | |
| 22 | | 253 | 2 | | | | | | |
| | 13 | | | | −124 | | | | |
| 23 | | 260 | 15 | | | | | | |
| 24 | | 301 | | | | | | | |
| | 9 | | | 2922 | | | | | |
| | | | | | | 1015.5 | 890 | 30.5% | |
| 20 | | 473 | 15 | | | | | | II a |
| | 10 + 11 | | | | 1721 | | | | |
| 21 | | 232 | 0.6 | | | | | | |
| | 8 + 12 | | | −4486 | | | | | |
| 22 | | 220 | 0.6 | | | | | | |
| | 13 | | | | −123 | | | | |
| 23, 24 | | 224 | 15 | | | | | | |
| | 19 | | | 5598 | | | | | |
| | | | | | | 1721 | 1599 | 31.0% | |
| 20 | | 473 | 15 | | | | | | II b |
| | 10 + 11 | | | | 1721 | | | | |
| 21 | | 232 | 0.6 | | | | | | |
| | 8 + 12 | | | −3556 | | | | | |
| 22 | | 220 | 0.6 | | | | | | |
| | 13 | | | | −123 | | | | |
| 23 | | 224 | 15 | | | | | | |
| 24 | | 301 | | | | | | | |
| | 9 | | | 2442 | | | | | |
| | | | | | | 1721 | 1599 | 44.4% | |

1-17. (canceled)

18. A process for the production of electroenergy in a natural gas driven gas turbine and fluid turbine power station (GuF-power station), the process comprising:
driving the power station with pure oxygen and natural gas as reactants in such way that the air containing nitrogen of an air driven power station is replaced by carbon dioxide, which is won by drying from the exhaust gas of the gas turbine as accompanying gas and the usual for the using of waste heat of the gas turbine used water-steam cycle is replaced completely by an carbon dioxide cycle and the media natural gas, air and carbon dioxide, which are used as primary substances are stored in separate high pressure storages, wherein the high pressure storage for natural gas is used as a fuel storage of the power station, the high pressure storage for pressured air is used as a buffer system for a continuous working air separation plant for the preferential production of liquid oxygen and the high pressure storage for carbon dioxide is making that available as heat transfer medium, which is taken off the heat content of the exhaust gases of the gas turbine in the fluid cycle by a heat exchanger as a heat source, therein is winning energy, after that labor-working expanded due an expansion machine, which is coupled with a generator for the production of electric energy, is expanded and cooled in this process, after that is liquefied due two heat exchanger at least and in liquid state compressed in the pump to the working pressure again and giving back to the high pressure storage for carbon dioxide.

19. A process as claimed in claim 18, wherein the labor-working expansion is made into the range of vapor-liquid equilibrium with a partial condensation of carbon dioxide and the vapor-liquid-mixture is liquefied totally and in liquid state compressed to the working pressure and stored interim storage.

20. A process as claimed in claim 18, wherein salt caverns are used as high pressure storages in big deep.

21. A process as claimed in claim 18, wherein the geothermal potential in 5 to 30 meters deep is used as cold source to remove the heat of condensation of carbon dioxide at last partially.

22. A process as claimed in claim 18, wherein the temperature of the waste air of the air separation plant is used as cold source to remove the heat of condensation of carbon dioxide at last partially.

23. A process as claimed in claim 18, wherein the ambient temperature or substances which are tempered by the ambient air are used as cold source to remove the heat of condensation of carbon dioxide at last partially.

24. A process as claimed in claim 18, wherein the temperature of the water of seas, rivers and oceans is used as cold source to remove the heat of condensation of carbon dioxide at last partially.

25. A process as claimed in claim 18, wherein the deep temperature potential of the labor-working preferably two-stage expansion of natural gas is used as cold source to remove the heat of condensation of carbon dioxide at last partially.

26. A process as claimed in claim 18, wherein the deep temperature potential of the labor-working preferably two-stage expansion of compressed air to the input pressure of the air separation plant is used as cold source to remove the heat of condensation of carbon dioxide at last partially.

27. A process as claimed in claim 18, wherein the heat of vaporization and the cold potential of the in the process used liquid oxygen is used as cold source to remove the heat of condensation of carbon dioxide at last partially in such way that, as prevention of the forming of crystalline carbon dioxide in the first heat exchanger, is made a preheating of the deep-cold oxygen, which is used as a cooling medium, in a closed partial cycle of the vaporized oxygen due a heat exchanger, by using the third heat exchangers and the evaporator.

28. A process as claimed in claim 18, wherein the geothermal heat potential deeper strata of earth is used as an additional heat source.

29. A process as claimed in claim 18, wherein salt caverns act both as fluid storages for compressed supercritical carbon dioxide and as heat exchanger in the process and the storages act as an additional carbon dioxide capture under defined controlled conditions.

30. A process as claimed in claim 18, wherein the high pressure storage for carbon dioxide is topped continuously by using of dried exhaust gases of the power plant in such way that first the gases are compressed by a compressor to a pressure, which can be used to liquefy carbon dioxide with the given cold potential e.g. by using of the cold waste air of the air separation plant due the heat exchanger, the liquid product is collected in the container and then the liquefied carbon dioxide is compressed by a liquid pump and given into the high pressure storage for carbon dioxide.

31. A process as claimed in claim 18, wherein the geothermal heat potential of earth in the depth of 8 to 30 is used for the liquefaction of carbon dioxide while the deep storage because the high pressure of 100 bar at last is made in a depth of 400 meters at last in doing so that the hydrostatic pressure reduces the necessary costs for compression.

32. A process as claimed in claim 18, wherein the process is combined with a peak load power station on the basis of natural gas and is working discontinuously in such way that temporary overcapacity energy is used to fill high pressure storages for natural gas, compressed air, and the working fluid carbon dioxide in salt caverns under a pressure of 10 to 20 MPa as buffer and taking out pressured air from the pressured air storage for driving an air separation plant at a pressure of 0.6 to 0.8 MPa to produce liquid oxygen continuously, to store it, and to draw off it by need discontinuously due a vaporizer in gaseous state together with natural gas from the high pressure storage for natural gas and the high pressure storage for carbon dioxide to use as well as supplier of geothermal heat and storage of carbon dioxide as working medium.

33. A process as claimed in claim 18, wherein the process is combined with gas turbine power station on the basis of natural gas which is working continuously in such way that temporary overcapacity energy is used to fill high pressure storages for natural gas, compressed air, and the working fluid carbon dioxide in salt caverns under a pressure of 10 to 20 MPa as buffer and taking out pressured air from the pressured air storage for driving an air separation plant at a pressure of 0.6 to 0.8 MPa to produce liquid oxygen continuously, to store it, and to draw off it by need continuously due a vaporizer in gaseous state together with natural gas from the high pressure storage for natural gas, and the high pressure storage for carbon dioxide is used as well as a supplier of geothermal heat and storage of carbon dioxide as working medium, it doing so that the container for liquid oxygen is working as a buffer and in this way changes in the operation mode of the power plant does not interfere with the air separation plant.

34. A process as claimed in claim 18, wherein a part of the exhaust air after the carbon dioxide heat exchanger with cooling and recompressing, respectively due addition of carbon dioxide from the high pressure storage for carbon dioxide and compressed-oxygen from the vaporizer is given into the mixing plant and then into the combustion chamber of the gas turbine in such way that the pressure of the combustible gas and the pressure of the mixture of cleaned exhaust air, carbon dioxide and oxygen is adapted to the optimal input pressure of the gas turbine.
